(19) United States
(12) Patent Application Publication
(10) Pub. No.: US 2026/0084133 A1
(43) Pub. Date: Mar. 26, 2026

(54) PLASMA SYSTEM FOR CARBON DIOXIDE CONVERSION TO CARBON MONOXIDE

(71) Applicant: NANOPRO TECHNOLOGIES LTD., Tel Aviv-Yafo (IL)

(72) Inventors: Dmitry MEDVEDEV, Moscow (RU); Roman ILIEV, Moscow (RU); Boris MISLAVSKY, Moscow (RU)

(21) Appl. No.: 19/117,447

(22) PCT Filed: Oct. 2, 2023
(86) PCT No.: PCT/IB2023/059850

§ 371 Date: Apr. 1, 2025

Related U.S. Application Data
(60) Provisional application No. 63/412,403, filed on Oct. 1, 2022.

(51) Int. Cl. B01J 19/08; C01B 32/40

(52) U.S. Cl. CPC B01J 19/088; C01B 32/40; B01J 2219/00164; B01J 2219/00186; B01J 2219/0894

(57) ABSTRACT

There is provided a system and method for plasma discharge induced reduction of CO2 to CO in the presence of a predetermined amount of a reducing agent (i.e. methane or hydrogen).

### CROSS REFERENCE TO RELATED APPLICATIONS

This application claims the benefit of priority of U.S. Provisional Patent Application No. 63/412,403, filed Oct. 1, 2022, the contents of which are all incorporated herein by reference in their entirety.

### FIELD OF THE INVENTION

The present invention generally to invention relates to conversion of carbon dioxide (CO2) to carbon monoxide (CO). More specifically, the present invention relates to a system for conversion of carbon dioxide (CO₂) to carbon monoxide (CO) at a predefined conversion range.

### BACKGROUND OF THE INVENTION

Development of efficient technology of CO₂ utilization is a key condition of realistic transition to green CO₂-free industry. The problem is not only to make energy generation as a completely green process but to make all other industry processes (agriculture, metallurgy, cement production etc.) as CO₂ free. Only complete utilization of CO₂ generated in industry process can solve task instead of underground CO₂ storage which is only temporary solution. Ideally CO₂ should be utilized to production of some valuable product which have practically unlimited market comparable with giant scales of CO₂ generation in industrial processes. Such product is carbon monoxide, or CO. CO is a precursor for many chemical processes which can be used for manufacturing of drugs, fragrances, fuels, plastics and many other valuable products. Thus, while generation of CO₂ is considered an undesirable waste product from an environmental perspective, CO is actually a useful chemical component of many chemical processes.

Efficient technology of CO₂ conversion to CO can also have new applications that can solve global problem of hydrogen manufacturing and transportation.

For CO₂ dissociation, there are several known processes of conversion of CO₂ to CO which use plasma for stimulation of reaction. One plasma process is called “methane dry reforming” that uses a 50%/50% mixture of CO₂ with methane by volume:

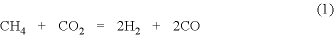

In this process CO as a reaction product can be produced. Conversion of high amount of methane to hydrogen takes place together with CO₂ utilization. The drawback of this process is the need for complex technology of separation reaction products from each other and from residual initial reagents. A simplified gas separation flowchart for this process is presented in FIG. 1, showing a plasma reactor 104 supplied with a power supply 102. The plasma reactor 104 receives two inputs—50% is methane, and 50% is CO₂. The output of the plasma reactor 104 is fed through a compressor 106 into a first gas separation stage 108. The first gas separation stage 108 produces four outputs—H₂ and CO₂, and methane and CO. H₂ and CO₂ are fed through a compressor 110 into a second gas separation stage 112, and the methane and CO are fed into the third gas separation stage 114. The CO is then taken out as the useful product, and the other components are fed back into the plasma reactor.

A real gas separation system is much more complicated and has many stages to ensure product purity. Each stage requires additional gas pressurizing energy consumption, which increases final products energy costs.

A direct process of CO₂ dissociation by plasma is also known, as shown by the reaction:

(2) CO₂═CO+½ O₂ This process also needs separation of CO and oxygen from each other and from residual CO₂ that should be returned to the reactor input for further treatment. Separation of CO₂, which can be done by membrane, TSA (temperature-swing adsorption) technology or PSA (pressure-swing adsorption) technology, produces explosive and flammable mixture of CO with oxygen which is dangerous for further treatment. Other problem of this process is the residual oxygen in the CO₂ returned flow which go back to reactor. This residual oxygen inevitably exists in recycled CO₂ flow and will increase CO production energy cost by stimulation of back reaction of CO oxidation. A simplified gas separation flowchart for this process is presented in FIG. 2, where the same components have the same reference numbers as in FIG. 1, and compressor 106 is added for the mixture of CO and oxygen.

Real gas separation systems are more complicated than the simple diagrams shown, but these problems will remain for all gas separation solutions.

### SUMMARY OF THE INVENTION

In one aspect of the invention, there is provided a system for generation of carbon monoxide (CO) from carbon dioxide (CO2), the system comprising: a plasma reactor; a CO2 source in fluid connection with a first valve; a reduction agent source in fluid connection with a second valve; wherein the first valve and second valve are controlled to provide a mixture of CO2 and the reduction agent to the plasma reactor at a predetermined molar ratio, and wherein the reduction agent is selected from hydrogen (H2) and methane (CH4), and wherein: the predetermined molar ratio between CO2 and CH4 is at least 3:1; the predetermined molar ratio between CO2 and H2 is at least 1:1; a compressor in fluid connection with an outlet of the plasma reactor; a water separator in fluid connection with an outlet of the compressor; and a gas separation membrane (GSM) in fluid connection with an outlet of the water separator comprising a CO outlet and a CO2 outlet.

In one embodiment, the molar ratios are calculated based on normal flow rates.

In one embodiment, the system further comprising: a first flowmeter for measuring a first flow rate of the CO2; a second flowmeter for measuring a second flow rate of the reduction agent; and a controller configured to: control the first valve and the second valve based on measurements received from the first flowmeter and the second flowmeter.

In one embodiment, the system further comprising a gas composition analyzer in fluid connection between the outlet of the water separator and an inlet of the GSM, and wherein the controller is further configured to control the first valve and the second valve based on a conversion rate of CO2, as determined by the gas composition analyzer.

In one embodiment, the controller is further configured to: set a required conversion rate; and adjust the first valve and the second valve until the required conversion rate is detected by the gas composition analyzer.

In one embodiment, the required conversion rate is below 65% measured in normal conditions.

In one embodiment, the required conversion rate is between about 30% and about 55%.

In one embodiment, the system further comprising, a recycling blower in fluid connection between a CO2 outlet of the GSM and the inlet of the plasma generator, and wherein the controller is further configured to control the first valve and the second valve based also on the flow of the recycled CO2.

In one embodiment, a gas at the CO outlet has a chemical purity of at least 99%, and wherein said gas has not more than 1% v/v of O2, H2 or both.

In one embodiment, a pressure of the mixture is between 5 to 20% higher than the pressure at the plasma reactor.

In one embodiment, the controller is further configured to control the power provided to the plasma generator.

In one embodiment, the power is controlled to provide the required conversion rate.

In another aspect, there is provided a method of generation of carbon monoxide (CO) from carbon dioxide (CO2), comprising: providing CO2 from a CO2 source to a plasma reactor at a first flow rate; providing a reduction agent from a reduction agent source to the plasma reactor at a second flow rate, to obtain a mixture of said CO2 and said reduction agent at a predetermined molar ratio, wherein the reduction agent is selected from hydrogen (H2) and methane (CH4), and wherein: the predetermined molar ratio between CO2 and CH4 is at least 3:1; or the predetermined molar ratio between CO2 and H2 is at least 1:1; wherein the providing is performed while generating electric discharge in the plasma reactor, for producing a gaseous product comprising CO, residual CO2 and water; separating the water from the gaseous product to CO and residual CO2; and separating the CO from the residual CO2.

In one embodiment, the method further comprising determining a conversion rate in the gaseous product and controlling the first flow rate and the second flow rate to obtain a required conversion rate.

In another aspect, there is provided a system for generation of carbon monoxide (CO) from carbon dioxide (CO2), the system comprising:
a plasma reactor configured for receiving a mixture of carbon dioxide (CO2) and methane (CH4) and for producing a mixture comprising water and CO;
a compressor configured for receiving and compressing the mixture of water and CO from the plasma reactor and for outputting a compressed mixture of liquid water and CO;
a water separator configured for receiving the compressed mixture and for removing the liquid water from the compressed mixture; and
a gas separation membrane configured for receiving the compressed mixture after removal of water and for separating CO from any residual carbon dioxide and for feeding the residual carbon dioxide back to the plasma reactor.

In one embodiment, the volume ratio of methane to carbon dioxide in the mixture of carbon dioxide and methane is up to 1:3.

In one embodiment, the methane supplied to the system is fully converted.

In one embodiment, the plasma reactor is an arc plasmatron.

In one embodiment, the plasma reactor is a gliding arc plasmatron.

In one embodiment, the plasma reactor is an RF plasmatron.

In one embodiment, the plasma reactor is a nanosecond pulsed plasma reactor.

In one embodiment, the plasma reactor is a microwave plasma reactor.

In one embodiment, the plasma reactor includes a recycling blower to ensure movement of gaseous components through the plasma reactor.

In one embodiment, the CO is liquefied and shipped by sea for subsequent hydrogen generation from water by shift reaction of CO with water.

In another aspect, there is provided a method for generating carbon monoxide (CO) from carbon dioxide (CO₂), the method comprising:
feeding a mixture of carbon dioxide and methane to a plasma reactor;
activating the plasma reactor to produce a mixture comprising gaseous water and CO;
compressing the mixture of water and carbon oxide to liquefy the water;
removing the liquid water from the compressed mixture;
separating the CO form from residual carbon dioxide in the compressed mixture; and
feeding the residual carbon dioxide back into the plasma reactor.

In one embodiment, the volume ratio of methane to carbon dioxide in the mixture of carbon dioxide and methane is up to 1:3.

In one embodiment, the methane supplied to the system is fully converted.

In one embodiment, the plasma reactor is an arc plasmatron.

In one embodiment, the plasma reactor is a gliding arc plasmatron.

In one embodiment, the plasma reactor is an RF plasmatron.

In one embodiment, the plasma reactor is a nanosecond pulsed plasma reactor.

In one embodiment, the plasma reactor is a microwave plasma reactor.

In one embodiment, the plasma reactor includes a recycling blower to ensure movement of gaseous components through the plasma reactor.

In one embodiment, the CO is liquefied and shipped by sea for subsequent hydrogen generation from water by shift reaction of CO with water.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates a conventional simplified gas separation flowchart of dry reforming process of CO generation;

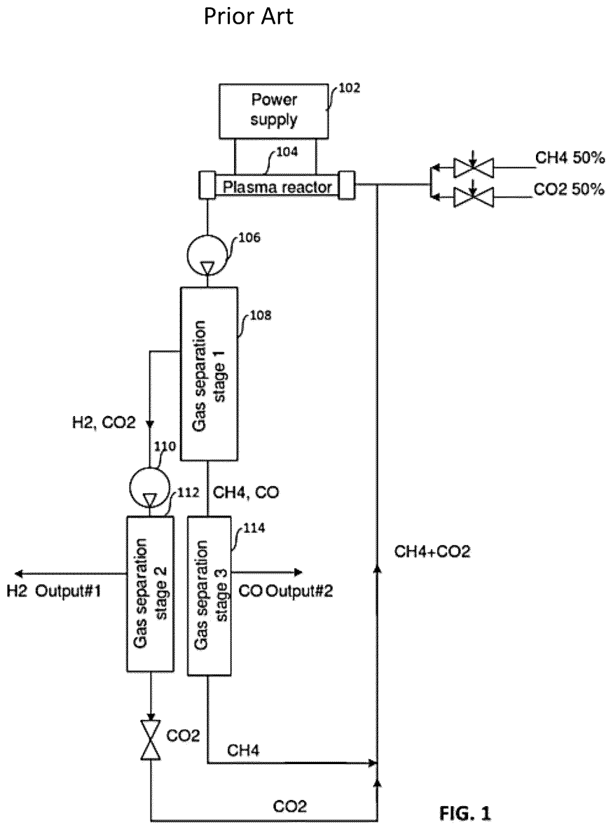

FIG. 2 illustrates a simplified gas separation flowchart for CO generation by CO₂ plasma dissociation process;

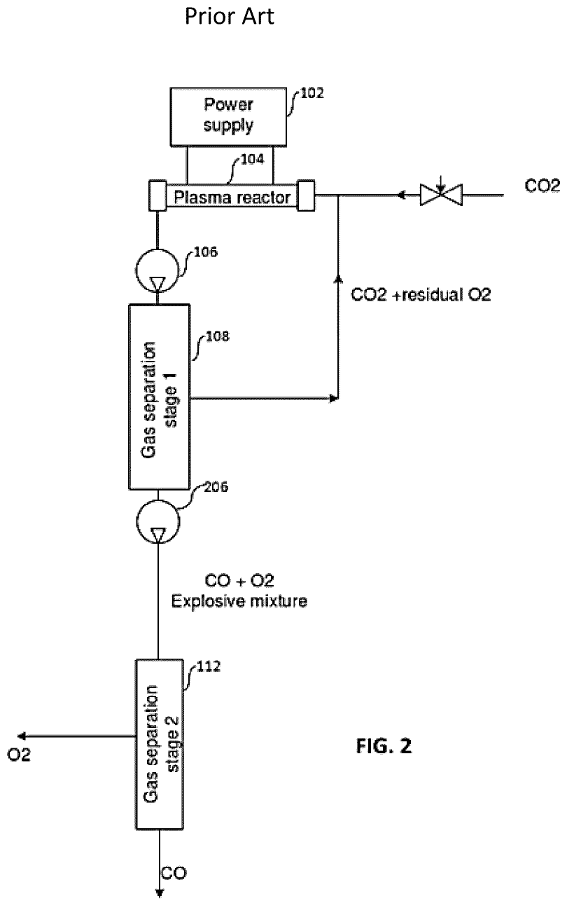

FIG. 3A is a block diagram depicting a system for generating CO from CO₂ according to some embodiments of the invention;

FIG. 3B is a flowchart of a method of generating CO from CO₂ according to some embodiments of the invention;

FIG. 4 illustrates the use of the technology for hydrogen generation and marine transportation according to some embodiments of the invention; and

FIG. 5 shows how CO₂ can be used in a recycle process for hydrogen generation and marine transportation according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

All plasma processes of CO manufacturing by CO₂ conversion need to be combined with gas separation technology in order to separate the product/sand to recycle of the initial regents. Efficient process of CO₂ conversion to CO should meet the following requirements:

1. Efficient plasma generation and separation of CO from other products and from residual CO₂ which should be returned back to the reactor input.

2. Scalability of the system up to any necessary capacity of the specific chemical plant consuming the CO. Preferably, in order to avoid expensive and dangerous CO transportation, the system should be installed in close proximity to the CO consuming chemical plant and to supply it with the necessary capacity.

The objective of the present invention is therefore to provide an efficient process and system for CO₂ to CO plasma-chemical conversion. Plasma-chemical conversion of pure CO₂ to CO and oxygen is inefficient because the resulting mixture of CO and oxygen is a flammable mixture. Thus, after only about 20% of CO₂ conversion, the resulting mixture will self-ignite and further conversion will be impossible.

For solution of problem of CO₂ conversion rate limitation and increase of CO generation energy cost close to mixture ignition limit, the inventors added a reducing agent (e.g., methane) to the CO₂ flow can be used. Alternatively, hydrogen can be also utilized as a reducing agent. The term “CO₂ conversion rate” is well-understood by a skilled artisan and refers to the molar ratio between the resulting CO (after the plasma-chemical reaction) relative to the initial amount of CO₂ fed to the plasma reactor.

Admixture of methane effectively neutralizes atomic oxygen by methane oxidation reaction, which further increases the yield of CO. Final integrated reaction of process can be presented as:

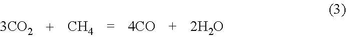

The inventors have found that for a complete stoichiometric reaction with zero oxygen output concentration, one methane molecule is required per four generated CO molecules or per 3 converted CO₂ molecules, but smaller ratios of methane admixtures can also improve CO production energy costs dramatically, because of a strong dependence of CO energy cost on oxygen concentration close to the mixture ignition limit. In this case, some residual oxygen concentration will remain in the gaseous product. The stoichiometric reaction or stoichiometric ratio is essential, since further to oxygen consumption the separation of the methane/CO mixture is very tedious. Accordingly, in order to optimize the entire process of CO2 to CO conversion, there is a need for a complete (stoichiometric) reaction of methane, so that the entire methane fed to the plasma reactor undergoes oxidation. Same is true in the case of using hydrogen as a reducing agent, however, the stoichiometric ratio between H2 and CO2 is 1:1.

Accordingly, the present invention in some embodiments thereof is based on a surprising finding that by limiting the CO₂ conversion rate up to about 65%, or up to about 60% results in a significant improvement of cost-effectiveness of the claimed process (i.e. CO₂ conversion to CO). Furthermore, the inventors have found that keeping the amount of the reducing agent fed to the plasma reactor within the limits of a stoichiometric conversion (not exceeding the stoichiometric ratio, so that the generated oxygen reacts completely with reducing agent and that the resulting gaseous product is substantially free of unreacted reducing agent) is essential for an optimal cost-effectiveness of the CO₂ conversion process disclosed herein.

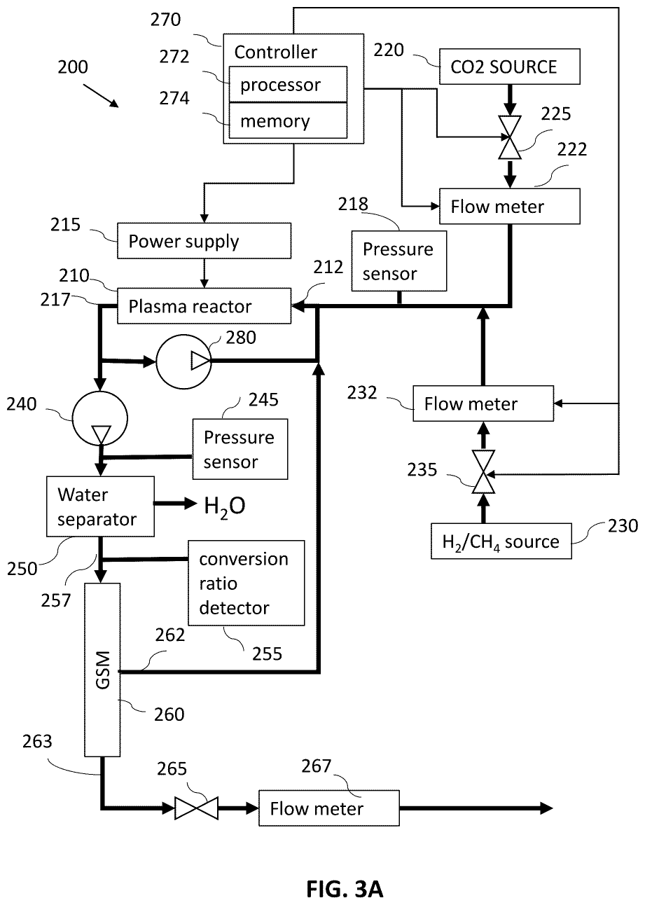

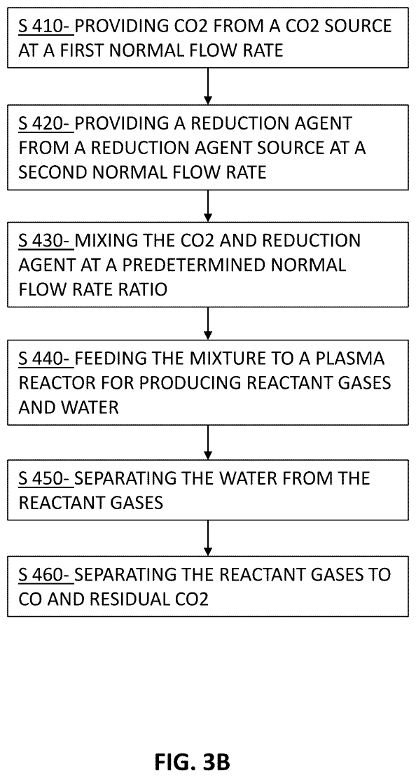

Reference is now made to FIG. 3A, which is a block diagram depicting a system for generating CO from CO₂ according to some embodiments of the invention. System 200 may include a plasma reactor 210 powered by a power source 215. Plasma reactor 210 may be fed with gases from a CO₂ source 220 and a reduction agent source 230, for example, via an inlet 212. As schematically illustrated in FIG. 3A, the bold lines indicate fluid connections between components and the thin lines of communication/electrical connections between components.

Plasma reactor 210 (also known as, plasmatron, plasma generator, etc.) is any reactor configured to cause an electric discharge in a gas. For example, plasma reactor 210 may be selected from an arc plasmatron, gliding arc plasmatron, RF plasmatron, nanosecond pulsed plasma reactor and microwave plasma reactor, and the like. In a nonlimiting example, the gas pressure inside reactor 210 may be between 1.05 to 10 atm, for example, 1.2 atm., 1.5 atm., 2 atm., 2.5 atm, 5 atm., 7 atm., 10 atm., and any value in between. In some embodiments, power supply 215 may provide between 5 to 100 kW, for example, 10 KW, 15 kW, 20 KW, 25 KW, 30, Kw, 50 kW, 75 KW, 95 kW, and any value in between. In some embodiments, power source 215 may be controlled by a controller, for example, a controller 270 as discussed herein below.

In some embodiments, CO₂ from CO₂ source 220 and the reduction agent from reduction agent source 230 may continuously be provided to reactor 210 to be processed by plasma. Therefore, gas-containing products of the reaction may continuously exit outlet 217 of reactor 210. In some embodiments, the gaseous product may include CO, residual reduction agent, residual CO₂, and water.

The term “reduction agent” encompasses a gas capable of reducing oxygen to water by plasma-assisted reaction.

In some embodiments, CO₂ source 220 is in fluid connection with a first valve 225 for controlling the flow rate of the CO₂. CO₂ source 220 may be a pressurized tank, a pipeline, and the like. In some embodiments, first valve 225 may be in fluid connection to a first flowmeter 222 for measuring the flow rate of the CO₂. In some embodiments, the CO₂ flow rate is between 2 to 10 m³/hour, measured for example, at normal conditions (e.g., at 1 atm. and 25° C.). As should be understood by the one skilled in the art, when different pressures or temperatures are used the range can be converted using the gas equation.

In some embodiments, reduction agent source 230 is in fluid connection with a second valve 235 and may be a pressurized tank, a pipeline, and the like. In some embodiments, second valve 235 may be in fluid connection to a second flowmeter 232 for measuring the flow rate of the reduction agent. In some embodiments, the reduction agent is selected from hydrogen (H₂) and methane (CH₄).

In some embodiments, first valve 225 and second valve 235 are controlled to provide a mixture of CO₂ and the reduction agent to plasma reactor 210 at a predetermined molar ratio. In some embodiments, the predetermined molar ratio between CO₂ and the reduction agent corresponds to a ratio equal or below the stoichiometric ratio, as disclosed herein.

In some embodiments, the predetermined molar ratio between CO₂ and CH₄ is at least 3:1, for example, 3.2:1, 3.5:1, 3.8:1, 4:1, 4.5:1, 5:1, 8:1, 10:1 and any value in between. In some embodiments, the predetermined molar ratio between CO₂ and CH₄ is between 3:1 and 30:1, between 3:1 and 20:1, between 3:1 and 10:1, 3:1 and 6:1, including any range between.

In some embodiments, the predetermined molar ratio between CO₂ and H₂ is at least 1:1, for example, at least 1.5:1, 2:1, 2.5:1, 3:1, and any value in between. In some embodiments, the predetermined molar ratio between CO₂ and H₂ is between 1:1 and 15:1, between 1:1 and 10:1, between 1:1 and 8:1, between 1:1 and 6:1, between 1:1 and 4:1, between 1:1 and 3:1, between 1:1 and 2:1, including any range between. In some embodiments, the molar ratios are calculated based on normal flow rates.

In some embodiments, first valve 225 and second valve 235 may be controlled by a controller, for example, controller 270 as discussed herein below.

In some embodiments, system 200 may further include a first pressure sensor 218 measuring the pressure of the mixture of CO₂ and reduction agent provided to inlet 212. In some embodiments, the pressure of the mixture is between 5 to 20% higher than the pressure at the plasma reactor, for example, 5%, 7%, 10%, 15%, and any value in between.

In some embodiments, system 200 may further include a compressor 240 in fluid connection with an outlet 217 of plasma reactor 210. Compressor 240 compresses the gaseous product of the reaction that took place inside reactor 210. In some embodiments, a second pressure sensor 245 may be connected to an outlet of compressor 240 for measuring the pressure of the gaseous product.

In some embodiments, system 200 may further include a water separator 250 in fluid connection with an outlet of compressor 240. Water separator 250 may separate water from the compressed mixture. Water separator 240 may include a cooler and liquid water filter. The water may be extracted from water separator 250, as shown.

In some embodiments, system 200 may further include a gas separation membrane (GSM) 260 in fluid connection with an outlet 257 of the water separator 250. GSM 260 may include a CO outlet 263 and a CO₂ outlet 262. GSM may be any membrane configured to separate between the CO and the CO₂. In a nonlimiting example GSM 260 may include polysulfone gas separation hollow fiber membrane.

In some embodiments, GSM 260 may separate between the CO and the CO₂, thereby providing at CO outlet 263 a gas product having CO₂ concentration not more than 5%, not more than 2%, not more than 1%, not more than 0.1%, not more than 0.01% by total volume of the gas product. In some embodiments, the CO gas product at the CO outlet 263 is characterized by a chemical purity (by volume) of at least 99%, for example, at least 99.1%, at least 99.4%, at least 99.6%, at least 99.7%, at least 99.8%, at least 99.9%, at least 99.99% or more. In some embodiments, the CO gas product at the CO outlet 263 is characterized by a volume concentration of at least one of oxygen, CO₂, and the reduction agent not more than 1%, not more than 0.1%, or between 10 ppm and 1, between 10 ppm and 0.1%, including any range between.

GSM 260 may separate between the CO and the CO₂, thereby providing at CO outlet 263 a gas product having has a chemical purity of at least 99% v/v CO, for example, at least 99.1% CO, at least 99.4% CO, at least 99.6% CO, at least 99.7% CO, at least 99.8% CO or more. In some embodiments, CO outlet 263 may be in fluid connection to CO valve 265 and CO flowmeter 267 for controlling the flow of the CO. In some embodiments, the CO gas has not more than 1% v/v of O₂, H₂ or both. In some embodiments, the CO gas after GSM 260 has trace amounts of at least one of: CO₂, O₂, or H₂.

In some embodiments, the gas product at the outlet 217 is characterized by a volume concentration of oxygen, and the reduction agent not more than 5%, not more than 4%, not more than 3%, not more than 2%, not more than 1%, not more than 0.5%, not more than 0.1%, including any range between.

In some embodiments, system 200 may further include a controller 270 for controlling various aspects, parameters and components of system 200. Controller 270 may include a processor 272 being any known processing unit (e.g., a chip) or processing service (e.g., in a cloud service). Processor 272 may execute code instructions saved in memory 274, for example, instructions for controlling the generation of CO using system 200.

For example, controller 270 may receive flow measurements from first flowmeter 222 and second flowmeter 232 and may control first valve 225 and second valve 235 based on measurements received from first flowmeter 222 and the second flowmeter 232.

In another example, controller 270 may set a required conversion rate between the CO and the CO₂ (as a product of the reaction in reactor 210) and may control first valve 225 and second valve 235 to provide the molar ratio between the CO₂ and the reduction agent that will result in the required conversion ratio. In a nonlimiting example, the required conversion rate is below 65% measured in normal conditions, for example, between about 30% and about 55%, about 10% and about 67%, about 10% and about 65% about 10% and about 62%, about 10% and about 60%, about 20% and about 55%, about 30% and about 55%, including any range between. As should be understood by the one skilled in the art, these are relatively low conversion rates, that were found by the inventors surprisingly beneficial for the production of highly pure CO at low energy costs. For example, the inventors have surprisingly found that at a conversion rate of 70%, the production costs are much higher than at a conversion rate of about 50% (see #2 and #4, in the Examples section). This contradicts what is known in the art, which requires as high conversion rates as possible.

In yet another example, controller 270 may further be configured to control the power provided to plasma reactor 210, for example, by controlling power source 215. In some embodiments, the power may be controlled/adjusted to provide the required conversion rate.

Therefore, in some embodiments, controller 270 may control one or more of the following parameters and components in order to cause plasma reactor 210 to produce CO at the required conversion rate. In some embodiments, the parameters and components are the first flow rate of the CO₂ controlled by first valve 225; the second flow rate of the reduction agent controlled by second valve 235; and the power provided to plasma reactor 210 from power source 215.

In some embodiments, system 200 may further include a gas composition analyzer 255 in fluid connection between outlet 257 of water separator 250 and an inlet of GSM 260. For example, gas composition analyzer 255 may be a spectroscopic gas analyzer, such as an infrared gas analyzer. In some embodiments, controller 270 may control first valve 225 and second valve 235 based on the conversion ratio detected by gas composition analyzer 255, for example, until the required conversion ratio is detected. In some embodiments, controller 270 may continuously monitor the conversion ratio, as to maintain the required conversion ratio during the entire conversion process.

In some embodiments, system 200 may further include a recycling blower 280 in fluid connection between CO₂ outlet 262 of the GSM 260 and inlet 212 of plasma generator 210. In some embodiments, controller 270 is further configured to control first valve 225 and second valve 235 based also on the flow of the recycled CO₂.

Reference is now made to FIG. 3B which is a flowchart of a method of generating carbon monoxide (CO) from carbon dioxide (CO₂) according to some embodiments of the invention. The method of FIG. 3B may be conducted using system 200, for example, under the supervision and control of controller 270 or any other suitable controller.

In step 310, the method may include providing CO₂ from a CO₂ source at a first flow rate. For example, CO₂ may be provided from CO₂ source 220 at first flow rate of between 2 to 10 m³/hour.

In step 320, the method may include providing a reduction agent from a reduction agent source at a second flow rate. For example, the reduction agent may be provided from reduction agent 230 at a second flow rate of between 1 to 5 m³/hour. In some embodiments, the method may comprise performing steps 310 and 320 simultaneously or subsequently.

In step 330, the method may include mixing the CO₂ and reduction agent to gain at a predetermined molar ratio. In some embodiments, mixing (step 330) is performed in a mixing chamber. In some embodiments, mixing (step 330) is performed in a gas feeding tube. In some embodiments, each gas is fed separately to the plasma reactor and the mixing (step 330) is performed inside the plasma reactor, to gain a mixture of CO₂ and the reduction agent. The plasma reactor may be equipped with a mixer (blower, or fan) which increases the mixing rate. A skilled artisan will appreciate that the diffusion rate of both gases fed to the plasma reactor (usually operating at a temperature between 10° and 300° C., or between 100 and 200° C.) maybe sufficient for a proper mixing.

In some embodiments, the predetermined molar ratio refers to a molar ratio of CO₂ and the reduction agent within the mixture, as disclosed above. In some embodiments, the predetermined molar ratio is at most the stoichiometric ratio (i.e. the amount of the reduction agent in the mixture/or relative to CO₂ fed into the reactor doesn't exceed the stoichiometric ratio). In some embodiments, the reduction agent is selected from hydrogen (H₂) and methane (CH4). In some embodiments, the predetermined molar ratio between CO₂ and CH₄ is at least 3:1, or the predetermined molar ratio between CO₂ and H₂ is at least 1:1, i.e. the amount of CH₄ or H₂ doesn't exceed the stoichiometric ratio for each reduction agent, respectively.

In step 340, the method may include feeding the mixture to a plasma reactor, while generating electric discharge in the plasma reactor, for producing a gaseous product comprising CO, the reduction agent, residual CO₂ and water. For example, the mixture may continuously be fed into plasma reactor 210, when the reactor is operative and generating electric discharge, thereby producing a gaseous product comprising CO, residual CO₂, and not more than 1% v/v of any one of: the reduction agent, O₂, H₂, or both. Alternatively, the mixture can be generated inside the reactor (in-situ), where each of the gases is separately fed to the reactor. Step 340 may result in the formation of a gaseous product comprising CO, residual CO₂ and water. The amount of the reduction agent, O₂, or both within the gaseous product after step 340 is not more than 1% v/v, or not more than 0.1% v/v.

In step 350, the method may include separating the water from the additional gases of the gaseous product. For example, the gaseous product may be introduced into water separator 250 in order to extract the water from the gaseous product to obtain a dry gaseous product.

In step 360, the method may include separating the CO from the residual CO₂. For example, the dry gaseous product may be introduced into GSM 260 to be separated into CO and residual CO₂. In some embodiments, CO after GSM 260 having a purity of at least 99% may exit via outlet 263, and residual CO₂ may exit via outlet 262. In some embodiments, the gas containing the residual CO₂ exiting via outlet 262 may further include residual CO.

In some embodiments, the method may further include recycling and refeeding the residual CO₂ into the mixture. For example, the residual CO₂ may be fed and mixed with the mixture of CO₂ and reduction agent prior to feeding the mixture to plasma reactor 210.

In some embodiments, the method may further include determining the conversion rate after step 340 (e.g. by analyzing the gaseous product using a gas composition analyzer and calculating the molar ratio between CO and CO₂ and consequently determining the conversion rate), and controlling (i) the first flow rate and the second flow rate (while maintaining the predetermined molar ratio between CO₂ and the reduction agent within the mixture), and/or (ii) the power, to obtain a required conversion rate, wherein the required conversion rate is as described herein.

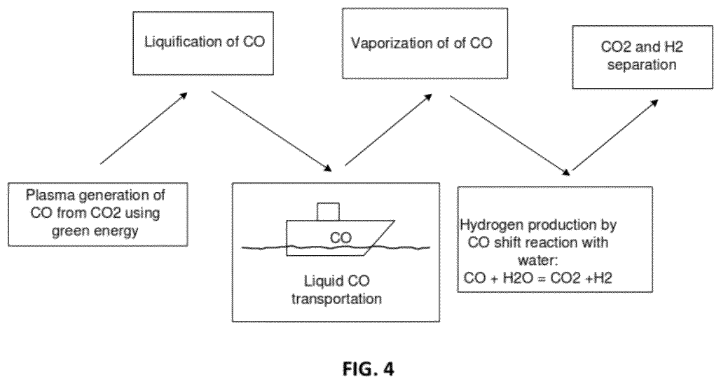

The described technology may therefore be used not only for CO₂ utilization and CO generation but also for hydrogen generation and through marine transportation of CO, as can be seen in FIG. 4. In some embodiments, CO generated from CO₂ can be liquefied and transported by similar conditions and similar techniques as liquefied natural gas transportation. CO liquification and liquid CO transportation is incomparably easier and safer compared to hydrogen liquification and transportation.

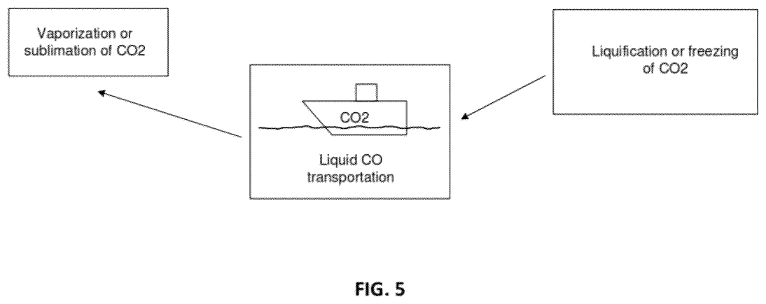

In some embodiments, to use the CO₂ in the recycle process, it can be transported back, as shown in FIG. 5.

All processes accompanying the described technology of plasma CO generation from CO₂ used in the hydrogen transportation are well known industrial processes implementing existing technique, as would be well understood by one of ordinary skill in the art.

### WORKING EXAMPLES

### Example #1

The following are nonlimiting examples of a process for producing CO from CO₂ and CH₄ using system 200. CO₂ at a normal flow rate of 6.95 m³/hour and CH₄ at a normal flow rate of 2.31 m³/hour may be provided from CO₂ source 220 and reduction agent source 230. The pressure of the mixture prior to entering inlet 212 was between 1.05 t 1.2 atm. The mixture was fed to plasma reactor 210 provided with a power of 19 kW from power source 215.

The gaseous product exit outlet 217 to be compressed by compressor 240 to a pressure of 1 Bar and further to be separated from the water in water separator 250. The process yield 3.7 liters/hour of water.

After the water separation, the gas contained 59.6 molar % CO and 40.4 molar % CO₂ at a normal flow rate of 17.1 m³/hour.

The gas then fed into GSM 260 and separated into CO having 99.8% purity and a normal flow rate of 9.2 m³/hour; and a gas containing 88.4 molar % CO₂ and 11.6 molar % CO and a normal flow rate of 7.8 m³/hour.

### Example #2

The system included a plasma reactor based on a DC plasmatron with a consumed power of 1.9 kW. The plasma reactor equipped with a recycling blower provides 5 m³/hour gas flow for normal plasmatron operation and gas flow cooler. The reactor is fed by 1 m³/hour fresh CO₂ from a gas cylinder. Inside the plasma reactor, CO₂ shows 12% dissociation to CO and O₂. After admixing of 10% of methane to CO₂ flow, CO output concentration increases up to 35%.

### Example #3

The system includes a plasma reactor based on a pulsed plasmatron, with a consumed power of 1.5 kW. The plasma reactor equipped with a recycling blower provides 15 m³/hour gas flow for normal plasmatron operation and gas flow cooler. The reactor is fed with 1 m³/hour fresh CO₂ from a gas cylinder. In the plasma reactor, CO₂ shows 14% dissociation to CO and O₂. After admixing of 10% of methane to CO₂ flow, CO output concentration increase up to 38%.

### Example #4

The system includes a plasma reactor based on pulsed nanosecond hot discharge in gas flow, with a consumed power of 2.5 kW. The plasma reactor equipped by recycling blower to provide 20 m³/hour gas flow for normal reactor operation and gas flow heat exchanger. The system is fed by 1.5 m³/hour fresh CO₂ and 0.5 m³/hour of methane from gas cylinders. In plasma reactor CO₂ 30% dissociate to CO and O₂, and oxygen oxidize methane to water and CO. The compressor takes the flow from plasma reactor output, which is enough to balance constant pressure in plasmatron cycle and pressurize it up to 1 Bar. After the compressor gas flow goes to cooler to condensate water and water separator and then to a gas separation membrane system that separates residual CO₂ from the product gas CO. CO₂ flow returns back to the reactor input. Finally, at system output, 2 m³/hour of pure CO flow is produced. The membrane is a polysulfone gas separation hollow fiber membrane. Total energy cost of CO production is about 2.8 kW*hour per 1 m³ of CO.

Additional examples for illustration of optimal CO₂ conversion rate:

System consisting of plasma reactor based on pulsed nanosecond hot discharge in gas flow with consumed power 19 kW which is equal for all examples. Plasma reactor equipped by recycling blower to provide 400 m³/hour gas flow for normal reactor operation and gas flow cooling.

#1

| Input CO2 flow | 6.95 | m3/h |
|---|---|---|
| Input CH4 flow | 2.31 | m3/h |
| Plasma power | 19 | kW |
| CO2 conversion rate | 39.8% | |
| Output produced CO flow | 9.26 | m3/h |
| Produced CO energy cost | 2.05 | kW*h/m3 |

#2

| Input CO2 flow | 6.78 | m3/h |
|---|---|---|
| Input CH4 flow | 2.26 | m3/h |
| Plasma power | 19 | kW |
| CO2 conversion rate | 53.9% | |
| Output produced CO flow | 9.04 | m3/h |
| Produced CO energy cost | 2.1 | kW*h/m3 |

#3

| Input CO2 flow | 5.7 | m3/h |
|---|---|---|
| Input CH4 flow | 1.9 | m3/h |
| Plasma power | 19 | kW |
| CO2 conversion rate | 61.9% | |
| Output produced CO flow | 7.6 | m3/h |
| Produced CO energy cost | 2.5 | kW*h/m3 |

#4

| Input CO2 flow | 3.85 | m3/h |
|---|---|---|
| Input CH4 flow | 1.28 | m3/h |
| Plasma power | 19 | kW |
| CO2 conversion rate | 72.0% | |
| Output produced CO flow | 5.13 | m3/h |
| Produced CO energy cost | 3.7 | kW*h/m3 |

The inventors deduced from the examples above (entries 1-4) that the optimal conversion rate of CO should be below 70%, such as about 50%. Increasing the conversion rate above 60 or above 65% results in increased plasma energy costs making the entire process unfeasible.

Unless explicitly stated, the method embodiments described herein are not constrained to a particular order or sequence. Furthermore, all formulas described herein are intended as examples only and other or different formulas may be used. Additionally, some of the described method embodiments or elements thereof may occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A system for generation of carbon monoxide (CO) from carbon dioxide (CO₂), the system comprising:
a plasma reactor;
a CO₂ source in fluid connection with a first valve;
a reduction agent source in fluid connection with a second valve;
wherein the first valve and second valve are controlled to provide a mixture of CO₂ and the reduction agent to the plasma reactor at a predetermined molar ratio,
and wherein the reduction agent is selected from hydrogen (H₂) and methane (CH₄), and wherein:
the predetermined molar ratio between CO₂ and CH₄ is at least 3:1;
the predetermined molar ratio between CO₂ and H₂ is at least 1:1;
a compressor in fluid connection with an outlet of the plasma reactor;
a water separator in fluid connection with an outlet of the compressor; and
a gas separation membrane (GSM) in fluid connection with an outlet of the water separator comprising a CO outlet and a CO₂ outlet.

2. The system of claim 1, wherein the molar ratios are calculated based on normal flow rates.

3. The system of claim, further comprising:
a first flowmeter for measuring a first flow rate of the CO₂;
a second flowmeter for measuring a second flow rate of the reduction agent; and
a controller configured to:
control the first valve and the second valve based on measurements received from the first flowmeter and the second flowmeter.

4. The system of claim 3, further comprising:
a gas composition analyzer in fluid connection between the outlet of the water separator and an inlet of the GSM,
and wherein the controller is further configured to control the first valve and the second valve based on a conversion rate of CO₂, as determined by the gas composition analyzer.

5. The system of claim 3, wherein the controller is further configured to:
set a required conversion rate; and
adjust the first valve and the second valve until the required conversion rate is detected by the gas composition analyzer.

6. The system of claim 5, wherein the required conversion rate is below 65% measured in normal conditions.

7. The system of claim 5, wherein the required conversion rate is between about 30% and about 55%.

8. The system according to claim 2, further comprising, a recycling blower in fluid connection between a CO₂ outlet of the GSM and the inlet of the plasma generator, and wherein the controller is further configured to control the first valve and the second valve based also on the flow of the recycled CO₂.

9. The system according to claim 1, wherein a gas at the CO outlet has a chemical purity of at least 99%, and wherein said gas has not more than 1% v/v of O2, H₂ or both.

10. The system according to claim 1, wherein a pressure of the mixture is between 5 to 20% higher than the pressure at the plasma reactor.

11. The system according to claim 2, wherein the controller is further configured to control the power provided to the plasma generator.

12. The system of claim 11, wherein the power is controlled to provide the required conversion rate.

13. A method of generation of carbon monoxide (CO) from carbon dioxide (CO₂), comprising:
providing CO₂ from a CO₂ source to a plasma reactor at a first flow rate;
providing a reduction agent from a reduction agent source to the plasma reactor at a second flow rate, to obtain a mixture of said CO₂ and said reduction agent at a predetermined molar ratio,
wherein the reduction agent is selected from hydrogen (H₂) and methane (CH₄), and wherein:
the predetermined molar ratio between CO₂ and CH₄ is at least 3:1; or
the predetermined molar ratio between CO₂ and H₂ is at least 1:1;
wherein said providing is performed while generating electric discharge in said plasma reactor, for producing a gaseous product comprising CO, residual CO₂ and water;
separating the water from the gaseous product to CO and residual CO₂; and
separating the CO from the residual CO₂.

14. The method of claim 13, further comprising recycling and refeeding the residual CO₂ into the mixture.

15. The method of claim 13, wherein the first flow rate is between 2 to 10 m³/hour.

16. The method according to claim 13, wherein the second flow rate is between 1 to 5 m³/hour.

17. The method according to claim 13, wherein said gaseous product has not more than 1% v/v of any one of: said reduction agent, O₂, H₂ or both.

18. The method according to claim 13, further comprising determining a conversion rate in the gaseous product and controlling the first flow rate and the second flow rate to obtain a required conversion rate.

19. The method of claim 18, wherein the conversion rate is determined by a gas composition analyzer.

20. The system of claim 18, wherein the required conversion rate is below 65% measured in normal conditions.
